(19) United States
(12) Patent Application Publication
(10) Pub. No.: US 2024/0335721 A1
(43) Pub. Date: Oct. 10, 2024

(54) RESISTANCE BUOY FOR SWIMMING

(71) Applicant: Samuel P. Castillo, Chico, CA (US)

(72) Inventor: Samuel P. Castillo, Chico, CA (US)

(21) Appl. No.: 18/595,297

(22) Filed: Mar. 4, 2024

Related U.S. Application Data
(63) Continuation-in-part of application No. 18/355,411, filed on Jul. 20, 2023, now abandoned.
(60) Provisional application No. 63/390,964, filed on Jul. 20, 2022.

(51) Int. Cl. A63B 69/14; F16B 37/14; F16B 39/284

(52) U.S. Cl. CPC A63B 69/14; F16B 37/14; F16B 39/284; A63B 2225/605

(57) ABSTRACT

Disclosed herein is a swimming float and resistance device which can comprise a buoyant member having a first end and a second end, an elongated member having a first end and a second end, at least one cup having a wall and a base with a plurality of fenestrations, a fastening device, wherein said cup is removably attached to at least one end of said buoyant component via said elongated member and said fastening device such that the central axis of said cup is perpendicular to the central longitudinal axis of said buoyant component.

### CROSS-REFERENCE TO RELATED APPLICATIONS

The present application is a Continuation-in-Part application of prior-filed and co-pending U.S. Utility patent application Ser. No. 18/355,411, filed Jul. 20, 2023 which claims the benefit of priority under 35 U.S.C. § 119 to prior-filed U.S. Provisional Patent Application Ser. No. 63/390,964 filed Jul. 20, 2022, the complete contents each of which are hereby incorporated herein by reference.

### BACKGROUND

### Technical Field

The present device relates to the field of swimming equipment, particularly devices to provide flotation and resistance.

### Background

Swimmers are notorious for not using weights or strength training to improve and strengthen their swim stroke. Currently, there are very few options for fitness and competitive swimmers which provide the benefit of resistance training and encourage muscle growth while participating in their sport. Modification of swim suits and other external devices have been employed but most fail due their unwieldiness, lack of ready availability, cost, and lack of comfort by the user.

The “pull-buoy” is a commonly used device for perfecting and strengthening a swimmer's arm pull/swim stroke. “Pull-buoys” have historically been made of Styrofoam tubes held together by nylon straps or a molded plasticized Styrofoam. The “pull-buoy” is held between a swimmer's thighs to eliminate the need for kicking for forward propulsion and isolating muscle groups in a swimmer's upper body to improve the strength and quality of swimmer's arm pull.

Another tool used for the purpose of stroke improvement are hand paddles. Hand paddles are worn on both the left and right hands and are held in place by surgical tube straps. The paddles require additional physical exertion by a swimmer to pull themselves through the water and improve a stoke by allowing swimmers to physically feel the imperfections of their stroke as they pull themselves through the water.

The final tool commonly employed by swimmers to improve their physical strength is a “Kick-board”. Kickboards are commonly made of a plasticized Styrofoam and are held in front of a swimmer in the water as they kick their feet to propel themselves forward. Kickboards are also used by swimmers of all levels to improve their swim stroke by combining arm and hand motion while holding the floating board and moving through the water.

What is needed is a flotation device that also provides resistance. The addition of resistance creates additional drag for a swimmer as they move forward through the water. The added force necessary to locomote through the water will require a greater exertion of muscle groups in the upper body, core and legs used in the act of swimming therefore improving strength and musculature.

This is a molded plasticized Styrofoam flotation device with drag creating resistance cups of various sizes attached for the purpose of requiring swimmers to exert greater muscle use for the purpose of strengthening and improving their swim stroke.

### SUMMARY

The present device is a swimming buoy to support the legs while also providing additional resistance in a fluid environment.

### BRIEF DESCRIPTION OF THE DRAWINGS

Further details of the present device are explained with the help of the attached drawings in which:

FIG. 1 depicts a top perspective view of an embodiment of the present device.

FIG. 2a depicts a side view of an embodiment of the present device.

FIG. 2b depicts a top view of the embodiment shown in FIG. 2a.

FIG. 3a depicts a top view of an embodiment of a buoyant member component of the present device.

FIG. 3b depicts an end view of an embodiment of a buoyant member component of the present device.

FIG. 3c depicts an end view of an embodiment of a buoyant member component of the present device.

FIG. 3d depicts an end view of an embodiment of a buoyant member component of the present device.

FIG. 3e depicts an end view of an embodiment of a buoyant member component of the present device.

FIG. 3f depicts an end view of an embodiment of a buoyant member component of the present device.

FIG. 3g depicts an end view of an embodiment of a buoyant member component of the present device.

FIG. 3h depicts an end view of an embodiment of a buoyant member component of the present device.

FIG. 3i depicts an end view of an embodiment of a buoyant member component of the present device.

FIG. 3j depicts an end view of an embodiment of a buoyant member component of the present device.

FIG. 3k depicts an end view of an embodiment of a buoyant member component of the present device.

FIG. 3l depicts an end view of an embodiment of a buoyant member component of the present device.

FIG. 3m depicts an end view of an embodiment of a buoyant member component of the present device.

FIG. 4a depicts a top view of an embodiment of an elongated member and cup components of the present device.

FIG. 4b depicts a top view of an embodiment of an elongated member and cup components of the present device.

FIG. 4c depicts a top view of an embodiment of an elongated member and cup components of the present device.

FIG. 4d depicts a top view of an embodiment of an elongated member and cup components of the present device.

FIG. 4e depicts a top view of an embodiment of an elongated member and cup components of the present device.

FIG. 4f depicts a top view of an embodiment of an elongated member and cup components of the present device.

FIG. 4g depicts a top view of an embodiment of an elongated member and cup components of the present device.

FIG. 4h depicts a top view of an embodiment of an elongated member and cup components of the present device.

FIG. 4i depicts a top view of an embodiment of an elongated member and cup components of the present device.

FIG. 4j depicts a top view of an embodiment of an elongated member and cup components of the present device.

FIG. 5 depicts a perspective assembly view of an embodiment of the present device.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

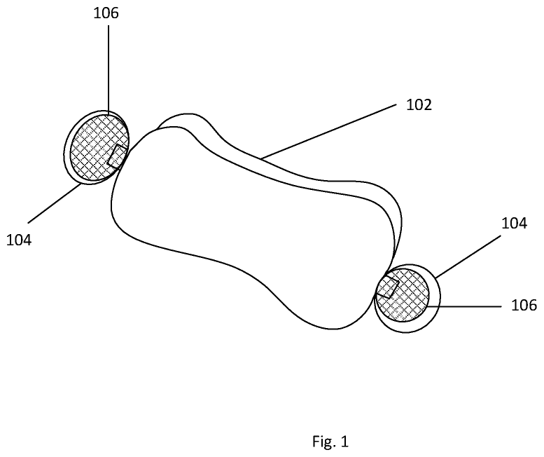

FIG. 1 depicts a top perspective view of an embodiment of the present device. A buoyant member 102 can have a modified rectangular geometry with a first end and a second end. A buoyant member 102 can be comprised of foam or any other known and/or convenient buoyant material. In some embodiments, a buoyant member 102 can have concave sides to comfortably fit between a user's legs.

As shown in FIG. 1, at least one cup 104 can be removably attached to each end of a buoyant member 102. The base of a cup 104 can have a plurality of fenestrations 106 to create a “sieve-like” surface at the base of a cup 104. In some embodiments a cup 104 can be attached to a buoyant member 102 such that the central axis of a cup 102 is substantially perpendicular to and substantially aligned with the central longitudinal axis of a buoyant member 102. However, in other embodiments cups 104 can be attached to any known and/or convenient location on a buoyant member 102.

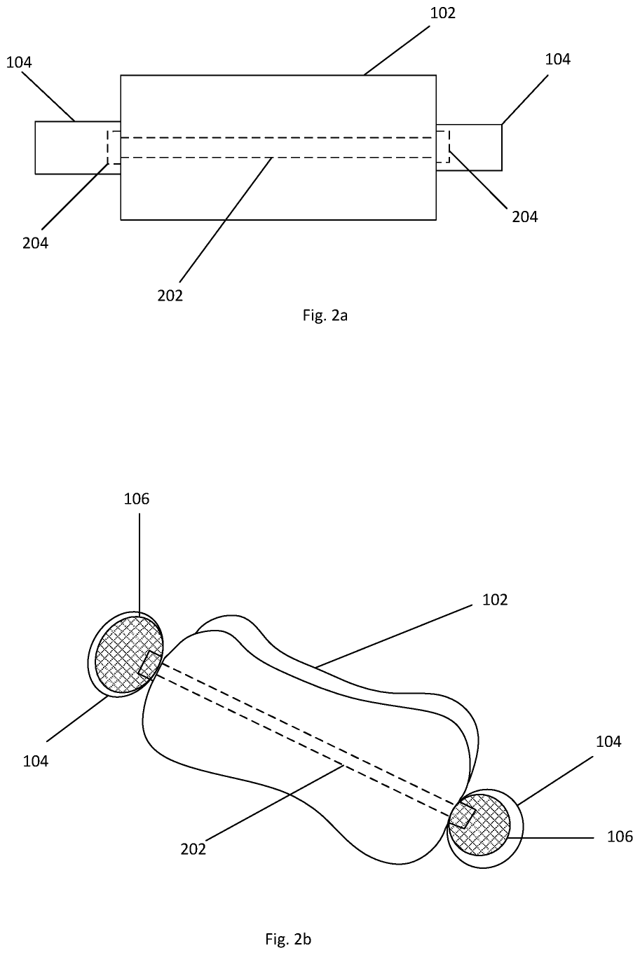

FIG. 2a depicts a side view of an embodiments of the present device. As shown in FIG. 2a, an elongated member 202 can extend longitudinally and substantially along the central longitudinal axis of a buoyant member 102 and through the side of a cup 104. End caps 204 can be connected to each end of an elongated member 202 via a threaded connection, friction fit, or any other known and/or convenient device. End caps 204 can be positioned on the inside surface of a cup 104 to removably connect a cup 104 to a buoyant member 102.

FIG. 2b depicts a top view of the embodiment shown in FIG. 2a. In some embodiments, different sized cups 104 can be interchangeable to vary the resistance experienced by a user. In other embodiments the pattern or number of fenestrations 106 can be varied to affect the resistance.

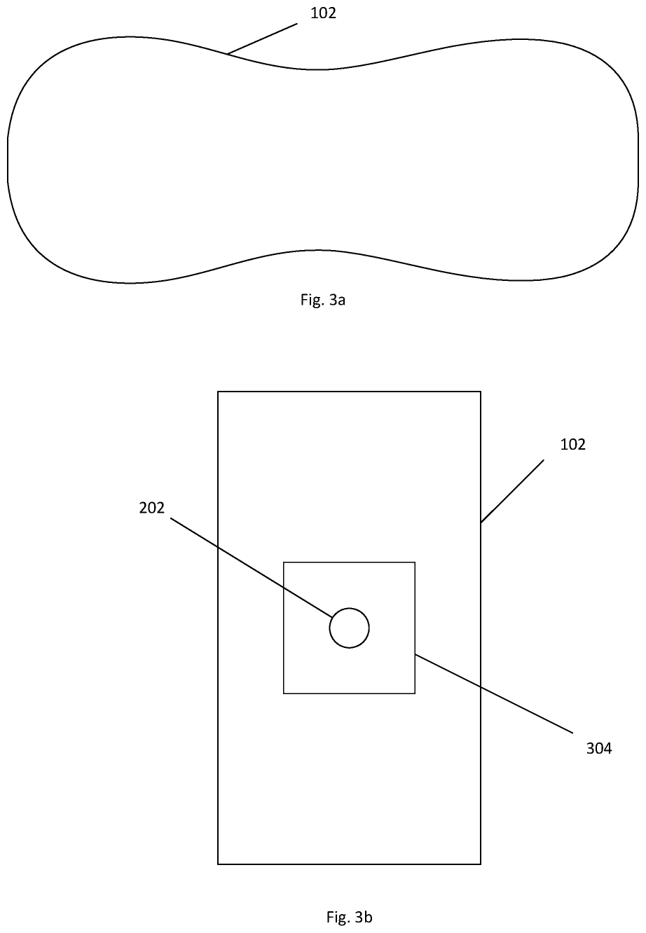

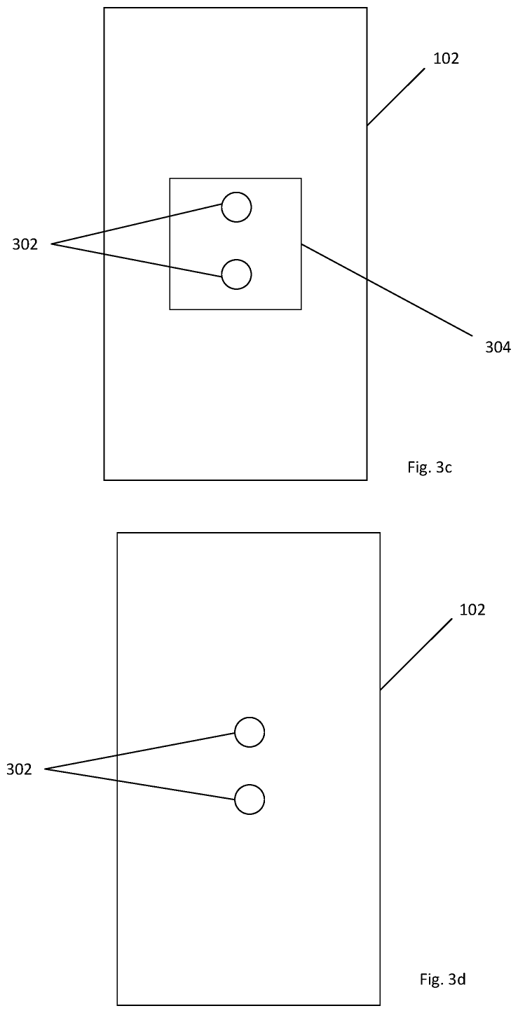

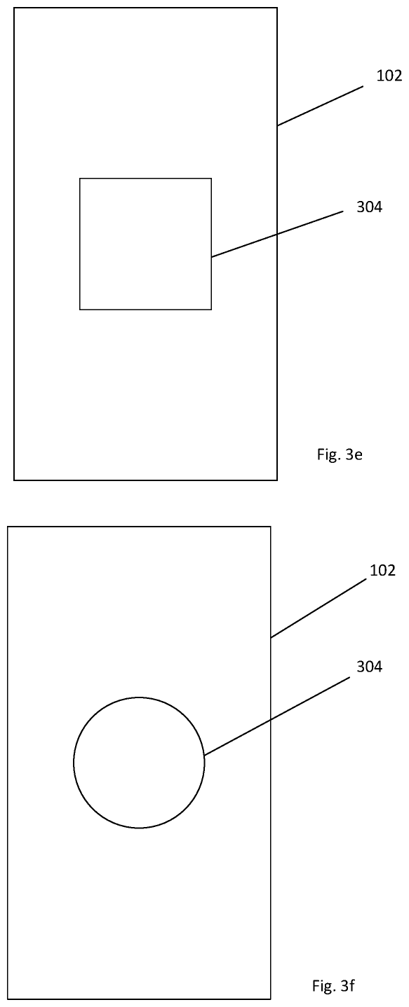

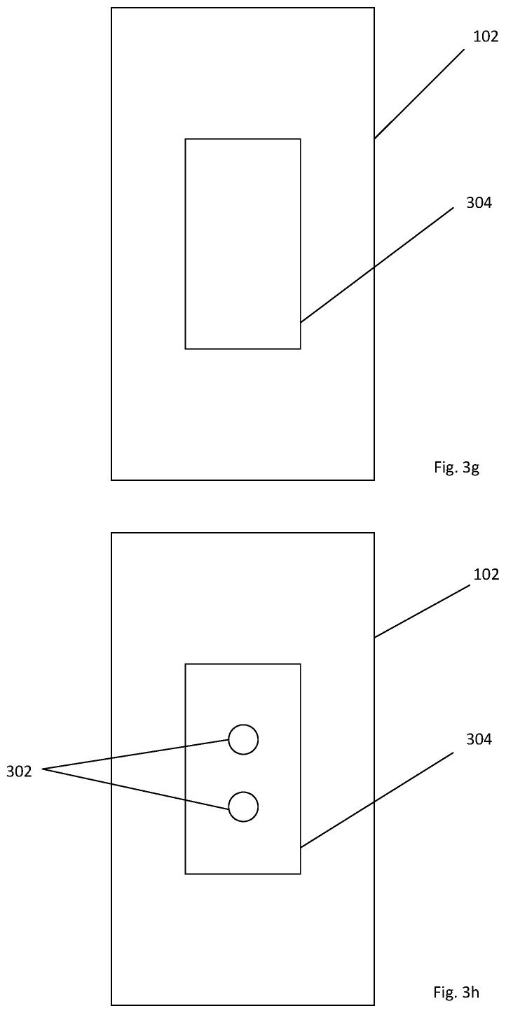

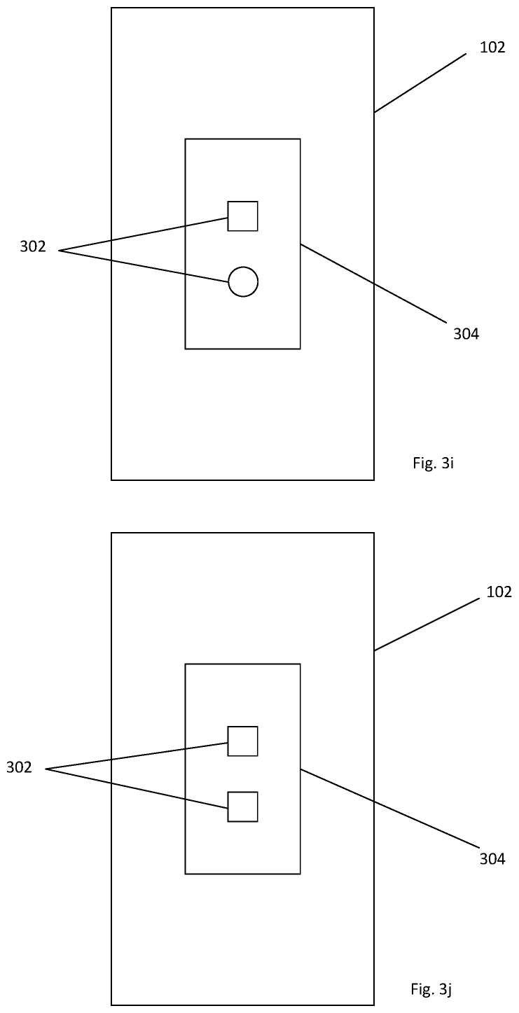

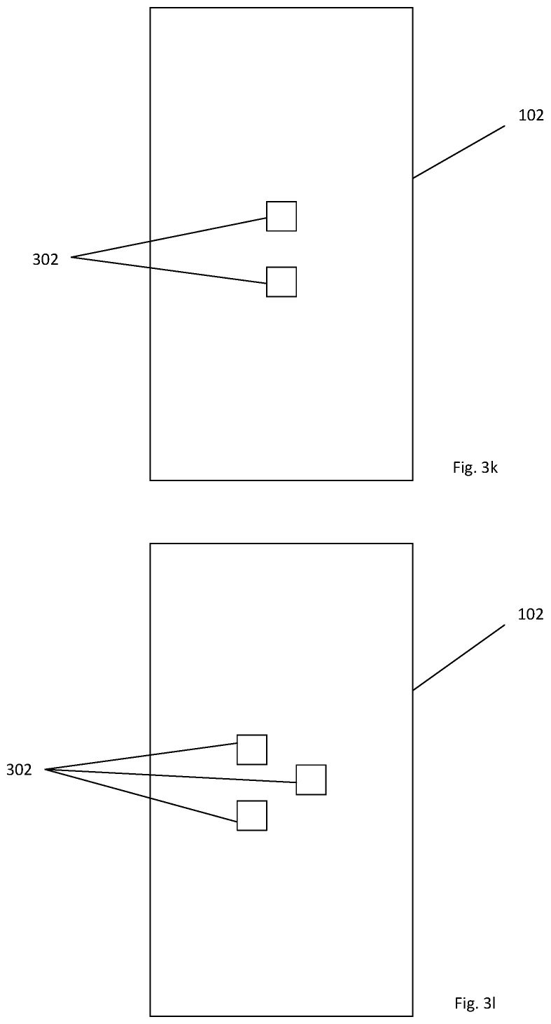

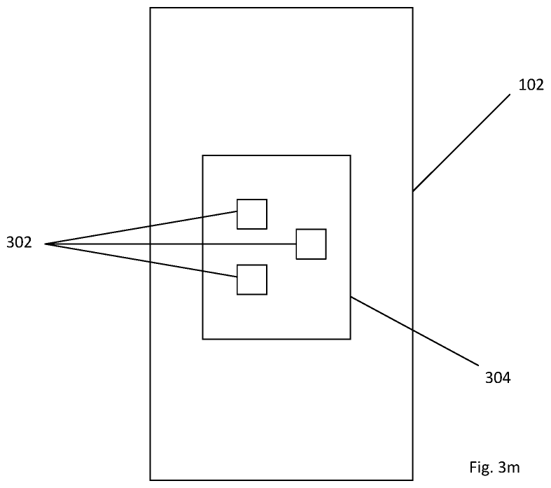

FIG. 3a depicts a top view of another embodiment of a buoyant member 102 of the present device. As shown in FIG. 3a, a buoyant member 102 can have a substantially rounded rectangular geometry, but in other embodiments can have any other known and/or convenient shape. In some embodiments, the longitudinal sides can be concave, but in other embodiments can have any other known and/or convenient configuration.

FIG. 3b depicts an end view of another embodiment of a buoyant member 102 of the present device. As shown in FIG. 3b, a buoyant member 102 can have a longitudinal member 202 extending substantially along the longitudinal axis of a buoyant member 102. In some embodiments, a longitudinal member 202 can have a substantially ellipsoid cross-sectional geometry, but in other embodiments can have any other known and/or convenient geometry. As shown in FIG. 3b, a longitudinal member 202 can have a substantially circular cross-sectional geometry. In such embodiments, the cross-sectional geometry of an elongated member 202 can selectively engage with a longitudinal opening of corresponding cross-sectional geometry running substantially along the longitudinal axis of a buoyant member 102

FIG. 3b also depicts an indentation 304 placed substantially in the center of at least one end of a buoyant member 102. In other embodiments, and indentation 304 can also be placed off-center or in any other known and/or convenient configuration. As shown in FIG. 3b, an indentation 304 can have a substantially square geometry, but in other embodiments can have any other known and/or convenient configuration. In some embodiments, an indentation 304 can be sized and configured to selectively engage with a lateral section of a cup 104 to prevent a cup 104 from rotating about the longitudinal axis of a buoyant member 102 in use.

FIG. 3c depicts an end view of another embodiment of a buoyant member 102 of the present device. As shown in FIG. 3c, a buoyant member 102 can have a pair of longitudinal members 202 extending substantially parallel to the longitudinal axis of a buoyant member 102. In such embodiments, a pair of longitudinal members 202 can be aligned substantially along the vertical longitudinal plane of a buoyant member 102, but in other embodiments can have any other known and/or convenient configuration. In some embodiments, an indentation 304 can be placed substantially in the center of at least one end of a buoyant member 102.

FIG. 3d depicts an end view of another embodiment of a buoyant member 102 of the present device. As shown in FIG. 3d, a buoyant member 102 can have a pair of longitudinal members 202 extending substantially parallel to the longitudinal axis of a buoyant member 102. In such embodiments, a pair of longitudinal members 202 can be aligned substantially along the vertical longitudinal plane of a buoyant member 102, but in other embodiments can have any other known and/or convenient configuration. In some embodiments, there can be a pair of longitudinal members 202 without the need for an indentation 304.

FIGS. 3e-g depict an end view of another embodiments of a buoyant member 102 of the present device an indentation 304 placed substantially in the center of at least one end of a buoyant member 102. As shown in FIG. 3e, an indentation 304 can have a substantially square geometry, but in other embodiments can have any other known and/or convenient configuration. As shown in FIG. 3f, an indentation 304 can have a substantially circular geometry, but in other embodiments can have any other known and/or convenient configuration. As shown in FIG. 3g, an indentation 304 can have a substantially rectangular geometry, but in other embodiments can have any other known and/or convenient configuration.

FIG. 3h depicts an end view of another embodiment of a buoyant member 102 of the present device. As shown in FIG. 3h, a buoyant member 102 can have a pair of longitudinal members 202 extending substantially along the longitudinal axis of a buoyant member 102. In some embodiments, longitudinal members 202 can have a substantially ellipsoid cross-sectional geometry, but in other embodiments can have any other known and/or convenient geometry. As shown in FIG. hb, a longitudinal member 202 can have a substantially circular cross-sectional geometry. In such embodiments, the cross-sectional geometry of an elongated member 202 can selectively engage with a longitudinal opening of corresponding cross-sectional geometry running substantially along the longitudinal axis of a buoyant member 102

FIG. 3h also depicts an indentation 304 placed substantially in the center of at least one end of a buoyant member 102. In other embodiments, and indentation 304 can also be placed off-center or in any other known and/or convenient configuration. As shown in FIG. 3h, an indentation 304 can have a substantially rectangular geometry, but in other embodiments can have any other known and/or convenient configuration. In some embodiments, an indentation 304 can be sized and configured to selectively engage with a lateral section of a cup 104 to prevent a cup 104 from rotating about the longitudinal axis of a buoyant member 102 in use.

FIG. 3i depicts an end view of another embodiment of a buoyant member 102 of the present device. As shown in FIG. 3i, a buoyant member 102 can have a pair of longitudinal members 202 extending substantially parallel to the longitudinal axis of a buoyant member 102. In some embodiments, one longitudinal member 202 can have a substantially ellipsoid cross-sectional geometry, while the other longitudinal member 202 can have a substantially rectangular cross-sectional geometry. As shown in FIG. 3i, a longitudinal member 202 can have an ellipsoid cross-sectional geometry that can be substantially circular, but in other embodiments can have any other known and/or convenient geometry. Another longitudinal member 202 can have a substantially rectangular cross-sectional geometry that can be substantially square. In such embodiments, the cross-sectional geometry of elongated members 202 can selectively engage with longitudinal openings of corresponding cross-sectional geometry running substantially parallel to the longitudinal axis of a buoyant member 102.

FIG. 3i also depicts an indentation 304 placed substantially in the center of at least one end of a buoyant member 102. In other embodiments, and indentation 304 can also be placed off-center or in any other known and/or convenient configuration. As shown in FIG. 3i, an indentation 304 can have a substantially rectangular geometry, but in other embodiments can have any other known and/or convenient configuration. In some embodiments, an indentation 304 can be sized and configured to selectively engage with a lateral section of a cup 104 to prevent a cup 104 from rotating about the longitudinal axis of a buoyant member 102 in use.

FIG. 3j depicts an end view of another embodiment of a buoyant member 102 of the present device. As shown in FIG. 3j, a buoyant member 102 can have a pair of longitudinal members 202 extending substantially parallel to the longitudinal axis of a buoyant member 102. In some embodiments, longitudinal members 202 can have a substantially rectangular cross-sectional geometry that can be substantially square. In such embodiments, the cross-sectional geometry of elongated members 202 can selectively engage with longitudinal openings of corresponding cross-sectional geometry running substantially parallel to the longitudinal axis of a buoyant member 102.

FIG. 3j also depicts an indentation 304 placed substantially in the center of at least one end of a buoyant member 102. In other embodiments, and indentation 304 can also be placed off-center or in any other known and/or convenient configuration. As shown in FIG. 3j, an indentation 304 can have a substantially rectangular geometry, but in other embodiments can have any other known and/or convenient configuration. In some embodiments, an indentation 304 can be sized and configured to selectively engage with a lateral section of a cup 104 to prevent a cup 104 from rotating about the longitudinal axis of a buoyant member 102 in use.

FIG. 3k depicts an end view of another embodiment of a buoyant member 102 of the present device. As shown in FIG. 3k, a buoyant member 102 can have a pair of longitudinal members 202 extending substantially parallel to the longitudinal axis of a buoyant member 102. In some embodiments, longitudinal members 202 can have a substantially rectangular cross-sectional geometry that can be substantially square. In such embodiments, the cross-sectional geometry of elongated members 202 can selectively engage with longitudinal openings of corresponding cross-sectional geometry running substantially parallel to the longitudinal axis of a buoyant member 102. In some embodiments, there can be a pair of longitudinal members 202 without the need for an indentation 304.

FIG. 3l depicts an end view of another embodiment of a buoyant member 102 of the present device. As shown in FIG. 3l, a buoyant member 102 can have a plurality of longitudinal members 202 extending substantially parallel to the longitudinal axis of a buoyant member 102. In some embodiments, there can be three longitudinal members 202, but in other embodiments there can be any other known and/or convenient number. In some embodiments, longitudinal members 202 can have a substantially rectangular cross-sectional geometry that can be substantially square. In such embodiments, the cross-sectional geometry of elongated members 202 can selectively engage with longitudinal openings of corresponding cross-sectional geometry running substantially parallel to the longitudinal axis of a buoyant member 102. In some embodiments, there can be a pair of longitudinal members 202 without the need for an indentation 304.

FIG. 3m depicts an end view of another embodiment of a buoyant member 102 of the present device. As shown in FIG. 3m, a buoyant member 102 can have a plurality of longitudinal members 202 extending substantially parallel to the longitudinal axis of a buoyant member 102. In some embodiments, there can be three longitudinal members 202, but in other embodiments there can be any other known and/or convenient number. In some embodiments, longitudinal members 202 can have a substantially rectangular cross-sectional geometry that can be substantially square. In such embodiments, the cross-sectional geometry of elongated members 202 can selectively engage with longitudinal openings of corresponding cross-sectional geometry running substantially parallel to the longitudinal axis of a buoyant member 102.

FIG. 3m also depicts an indentation 304 placed substantially in the center of at least one end of a buoyant member 102. In other embodiments, and indentation 304 can also be placed off-center or in any other known and/or convenient configuration. As shown in FIG. 3m, an indentation 304 can have a substantially rectangular geometry, but in other embodiments can have any other known and/or convenient configuration. In some embodiments, an indentation 304 can be sized and configured to selectively engage with a lateral section of a cup 104 to prevent a cup 104 from rotating about the longitudinal axis of a buoyant member 102 in use.

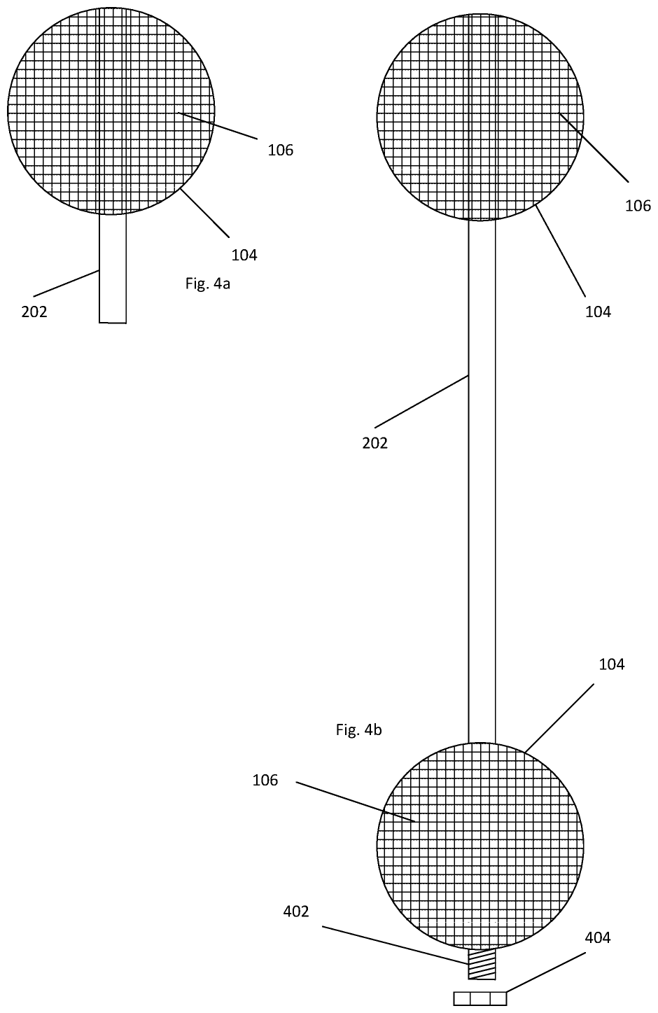

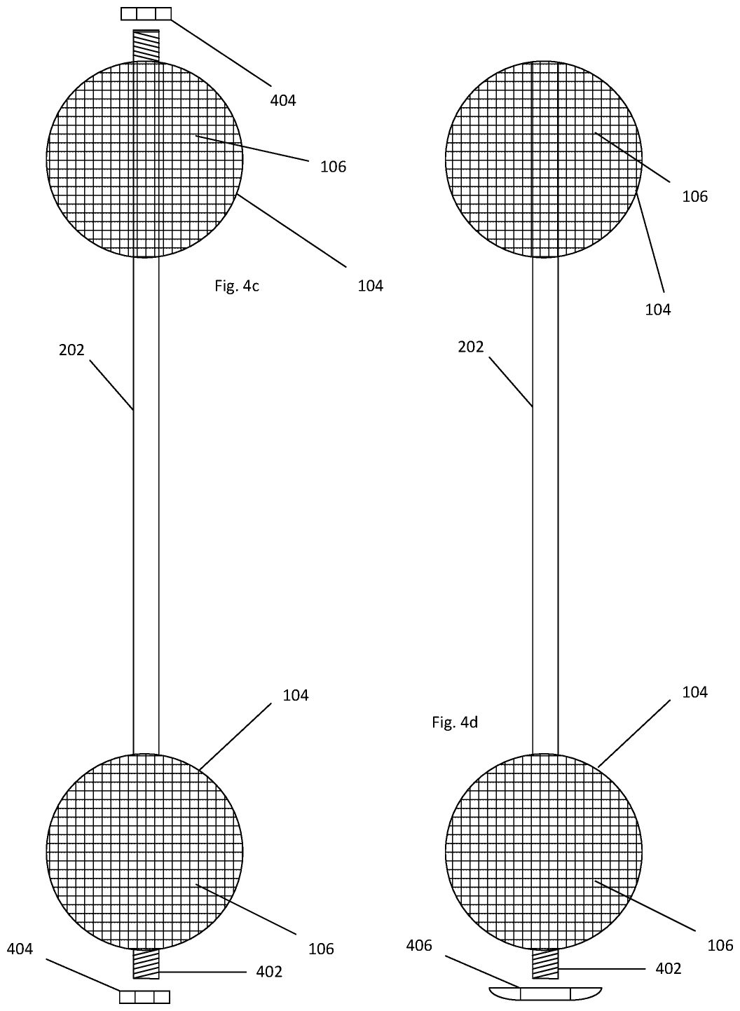

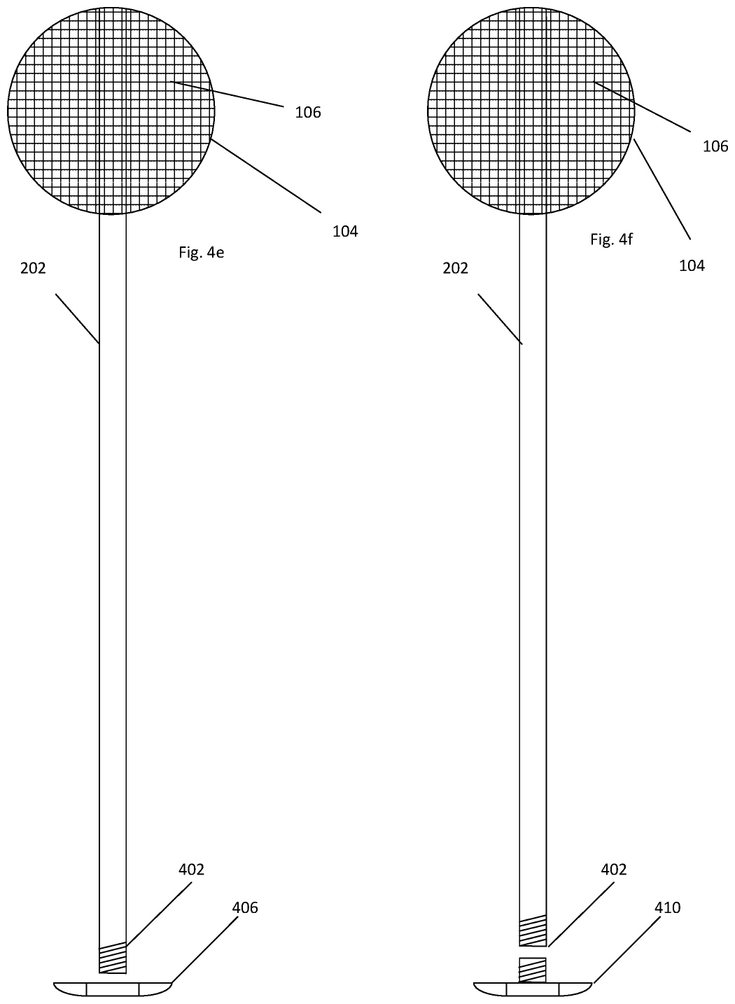

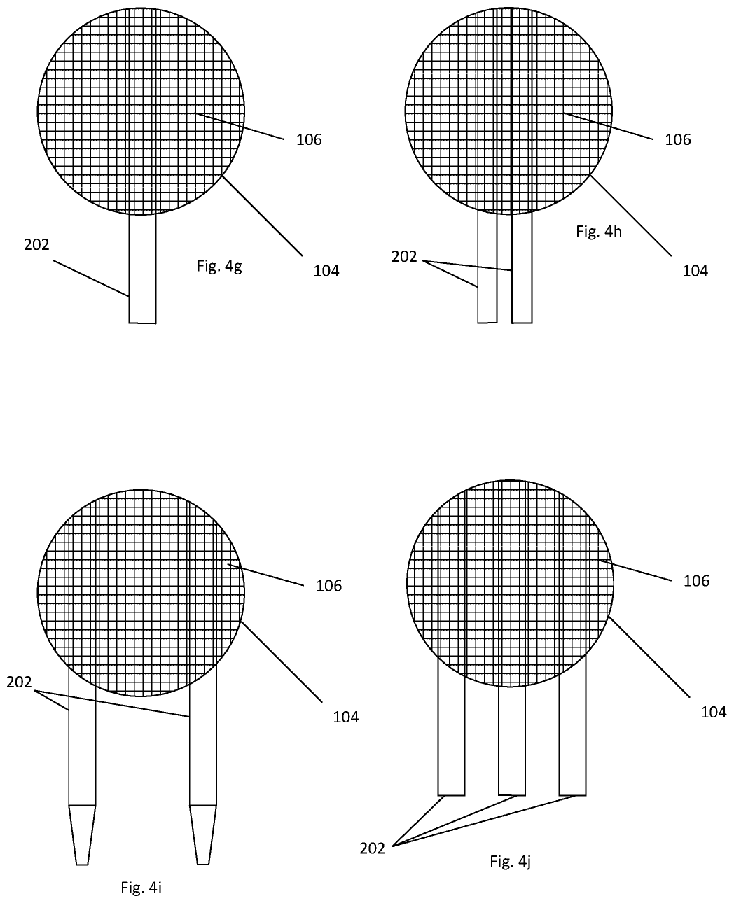

FIG. 4a depicts a top view of an embodiment of an elongated member 202 and cup 104 components of the present device. As shown in FIG. 4a, an elongated member 202 can have a length less than that of a buoyant member 102. An elongated member 202 can be affixed to, removably attached to, or integrated with a cup 104. In some embodiments, a cup 104 can have a substantially circular geometry, but in other embodiments can have any other known and/or convenient configuration. In such embodiments, as shown in FIG. 4a, an elongated member 202 can extend substantially along the diameter of a cup 104, such that an elongated member 202 can extend beyond one edge of a cup 104, but not past the opposite edge. The base of a cup 104 can have a plurality of fenestrations 106 created by a mesh configuration, but in other embodiments can have fenestrations in any other known and/or convenient pattern.

FIG. 4b depicts a top view of another embodiment of an elongated member 202 and cup 104 components of the present device. In some embodiments, an elongated member 202 can be affixed, removably attached to, or integrated with a cup 104 on one end. An elongated member 202 can pass substantially along a diameter through a cup 104 and extend past the opposite edge. In some embodiments a cup 104 can be removably attached to the end of an elongated member 202 via a fastening device 401. In such embodiments, as shown in FIG. 4b, a fastening device 401 can comprise an externally threaded end 402 of an elongated member 202 that can selectively engage with a threaded nut 404 on the exterior of a cup 104. In other embodiments, a fastening device 401 can be a press fit, locking cap, or any other known and/or convenient device.

FIG. 4c depicts a top view of another embodiment of an elongated member 202 and cup 104 components of the present device. As shown in FIG. 4c, an elongated member 202 can be externally threaded at both ends 402. In such embodiments, each end of an elongated member 202 can pass substantially along a diameter through a cup 104 and extend past the opposite edge. A cup 104 can be removably attached to each end of an elongated member 202 via a fastening device 401. In such embodiments, as shown in FIG. 4c, a fastening device 401 can comprise an externally threaded end 402 of an elongated member 202 that can selectively engage with a threaded nut 404 on the exterior of a cup 104.

FIG. 4d depicts a top view of another embodiment of an elongated member 202 and cup 104 components of the present device. In some embodiments, an elongated member 202 can be affixed, removably attached to, or integrated with a cup 104 on one end. An elongated member 202 can pass substantially along a diameter through a cup 104 and extend past the opposite edge. A cup 104 can be removably attached to the end of an elongated member 202 via a fastening device 401. In such embodiments, as shown in FIG. 4d, a fastening device 401 can comprise an externally threaded end 402 of an elongated member 202 that can selectively engage with an internally threaded cap 406 on the exterior of a cup 104.

FIG. 4e depicts a top view of another embodiment of an elongated member 202 and cup 104 components of the present device. In some embodiments, an elongated member 202 can be affixed, removably attached to, or integrated with a cup 104 on one end. A cup 104 can be removably attached to the opposite end of an elongated member 202 via a fastening device 401. In such embodiments, as shown in FIG. 4e, a fastening device 401 can comprise an externally threaded end 402 of an elongated member 202 that can selectively engage with an internally threaded cap 406 on the exterior of a cup 104.

FIG. 4f depicts a top view of another embodiment of an elongated member 202 and cup 104 components of the present device. In some embodiments, an elongated member 202 can be affixed, removably attached to, or integrated with a cup 104 on one end. A cup 104 can be removably attached to the opposite end of an elongated member 202 via a fastening device 401. In such embodiments, as shown in FIG. 4f, a fastening device 401 can comprise an internally threaded end 402 of an elongated member 202 that can selectively engage with an externally threaded cap 404 on the exterior of a cup 104.

FIG. 4g depicts a top view of an embodiment of an elongated member 202 and cup 104 components of the present device. As shown in FIG. 4g, a single elongated member 202 can extend substantially along the diameter of a cup 104, such that an elongated member 202 can extend beyond one edge of a cup 104, but not past an opposite edge.

FIG. 4h depicts a top view of an embodiment of a pair of elongated members 202 and cup 104 components of the present device. As shown in FIG. 4h, a pair of elongated members 202 can extend substantially parallel to a diameter of a cup 104, such that each elongated member 202 can extend beyond one edge of a cup 104, but not past the opposite edge. In some embodiments, a pair of elongated members 202 can be positioned adjacent to and substantially parallel to a diameter.

FIG. 4i depicts a top view of an embodiment of a pair of elongated members 202 and cup 104 components of the present device. As shown in FIG. 4i, a pair of elongated members 202 can extend substantially parallel to a diameter of a cup 104, such that each elongated member 202 can extend beyond one edge of a cup 104, but not past the opposite edge. In some embodiments, a pair of elongated members 202 can be positioned adjacent to the circumference of a cup 104 and substantially parallel to a diameter. In some embodiments, a pair of elongated members 202 can terminate in substantially truncated cones 412, but in other embodiments can have any other known and/or convenient configuration.

FIG. 4j depicts a top view of an embodiment of a plurality of elongated members 202 and cup 104 components of the present device. As shown in FIG. 4j, a plurality of elongated members 202 can extend substantially parallel to a diameter of a cup 104, such that each elongated member 202 can extend beyond one edge of a cup 104, but not past the opposite edge. In some embodiments, a pair of elongated members 202 can be positioned adjacent to the circumference of a cup 104 and substantially parallel to a diameter, while an additional elongated member 202 can be positioned substantially along a diameter and substantially parallel to the other elongated members 202.

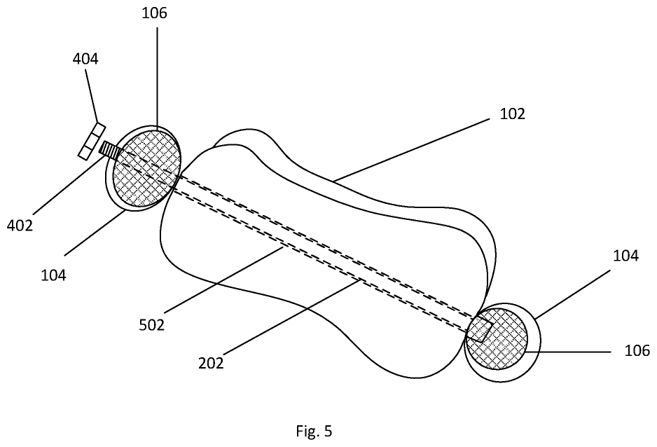

FIG. 5 depicts a perspective assembly view of an embodiment of the present device. As shown in FIG. 5, an elongated member 202 can extend through and beyond substantially along the longitudinal axis of a buoyant member 102. In such embodiments, a buoyant member 102 can have a longitudinal opening 502 that can selectively engage with an elongated member 202, which can be externally threaded on each end 402. An elongated member 202 can pass longitudinally through a buoyant member 102 such that its threaded ends 402 can extend past the ends of a buoyant member 102, through a cup 104 substantially along a diameter of said cup 104, with the threaded ends 402 extending past the opposite edge of a cup 104. In such embodiments, the externally threaded ends 402 of an elongated member 202 can selectively engage with nuts 404 to secure cups 104 to the ends of a buoyant member 102. In some embodiments, as shown in FIG. 5, cups 104 can selectively engage with indentations 304 to prevent rotation of cups 104 relative to the ends of a buoyant member 102.

In some embodiments, components buoyant member 102, elongated member 202, cups 104 and fastening device 401 can comprise a kit. In such embodiments, individual components can be added to a kit to provide more options to a user.

In use, a swimmer places the device between the legs to support the legs, which remain stationary. As the swimmer moves through the water, cups 104 provide additional resistance, requiring a swimmer to use additional strength to move themselves forward. This requires greater exertion by a swimmer to “pull” themselves forward through the water, thus improving their strength and conditioning.

Additionally, swimmers of different levels may opt to use different cups 104 to add or lessen the amount of resistance they desire in their swim workout. Drag-force created by the addition of cups 104 can improve a swimmer's wall push-off and streamline glide position by providing immediate ergonomic feedback with respect to optimal body posture in the water thus requiring greater engagement by leg muscle groups to maximize their wall push-off.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed is:

1. A swimming float and resistance device comprising:
a buoyant member having a first end and a second end;
an elongated member having a first end and a second end;
at least one cup having a wall and a base with a plurality of fenestrations;
a fastening device;
wherein said cup is removably attached to at least one end of said buoyant component via said elongated member and said fastening device such that the central axis of said cup is perpendicular to the central longitudinal axis of said buoyant component.

2. The float and resistance device of claim 1, further comprising an indentation in each end of a buoyant member that selectively engages with said cup to prevent axial rotation of said cup relative to said buoyant member.

3. The float and resistance device of claim 2, wherein said fastening device is comprised of a threaded end of said elongated member and a corresponding threaded nut.

4. The float and resistance device of claim 2, wherein said fastening device is comprised of a threaded end of said elongated member and a corresponding threaded cap.

5. The float and resistance device of claim 2, wherein said elongated member has a substantially cylindrical geometry.

6. The float and resistance device of claim 2, wherein said elongated member has non-threaded ends and further comprising a corresponding non-threaded cap such that when said cup selectively engages with said elongated member said cap removably secures said cup to said buoyant member.

7. The float and resistance device of claim 1, further comprising a plurality of interchangeable cups having different fenestration configurations.

8. A float and resistance device kit, comprising interchangeable components
a buoyant member having a first end and a second end;
an elongated member having a first end and a second end;
at least one cup having a wall and a base with a plurality of fenestrations; and
a fastening device.
